(19) United States
(12) Patent Application Publication
(10) Pub. No.: US 2022/0338662 A1
(43) Pub. Date: Oct. 27, 2022

(54) MOBILE SELF-CONTAINED COFFEE SHOP

(71) Applicant: BOSECO, INC., San Jose, CA (US)

(72) Inventors: Kostyantyn YUN, Odesa (UA); Ihor DUMA, Odesa (UA); Oleksandr KUZMIN, Odesa (UA); Ihor PINKOVSKYI, Odesa (UA)

(21) Appl. No.: 17/507,263

(22) Filed: Oct. 21, 2021

(30) Foreign Application Priority Data
Apr. 27, 2021 (UA) A202102220

(51) Int. Cl. A47J 31/00; A47J 31/40; A47J 31/44

(52) U.S. Cl. CPC A47J 31/007; A47J 31/404; A47J 31/407; A47J 31/4407

(57) ABSTRACT

A mobile self-contained coffee shop consists of a body and a lid, inside which there is a coffee machine for coffee in capsules or coffee pods, a water tank, connected to the coffee machine, an autonomous power source connected through an inverter to the coffee machine, a container for powder milk with a dispenser, a container for consumables, a container for used capsules, on the body there are buttons for controlling the coffee machine, and on the side surface of the body there is a hole in which the outlet of the coffee machine is located, the outlet of the dispenser and the stand for packaging cooked beverage.

The invention relates to commercial equipment, in particular to mobile foodservice outlets.

In the prior art, coffee machines, which are used in the catering industry for cooking coffee and coffee beverages are known.

In particular, it is known commercial equipment for cooking and sale of coffee and coffee beverages, consisting of a section for the coffee server's operational space, which is provided with electricity, a machine for cooking coffee and coffee beverages, which is connected to a water tank and a container for waste water and waste (Patent of the Russian Federation for utility model No. 111986, A23F 5/00, Publ. Oct. 1, 2012, Bulletin No. 1).

The disadvantage of this equipment is its stationary use, due to the need to connect the electric power supply from the grid with a view to ensuring the operation of the machine for cooking coffee and coffee beverages that makes it impossible to use it when organizing leisure in places of public events, parks, public gardens and promenade areas.

It is known a mobile foodservice outlet for cooking and selling coffee, consisting of a coffee machine, which is located on the desktop in the cargo compartment of the vehicle and is connected to gas equipment and a battery, and to an interchangeable water storage tank (Patent of the Russian Federation for utility model No. 122619, B60P 3/025, Publ. Oct. 12, 2012, Bul. No. 34).

It is known a mobile coffee shop, which was built on the base of a van mounted on a mobile platform. Inside the van there is a coffee machine, a water storage tank, a battery and an inverter, which is designed with an option to transform and supply current from a generator of the mobile platform or a car during their operation to the battery to which a coffee machine is connected (Patent of the Russian Federation for utility model No. 126661, B60P 3/025, Publ. Oct. 4, 2013, Bul. No. 10).

It is known a mobile coffee shop, chosen as the closest prior art, which is built on the base of a van mounted on a mobile platform or car. Inside the van there is a coffee machine, a water storage tank, a battery capable of being recharged from a generator of the mobile platform or a car, and an inverter, connected to the coffee machine, which is configured to transform current from the battery and a refrigerator for dairy products (Patent of the Russian Federation for utility model No. 134411, A47J 31/00, Publ. 20 Nov. 2013, Bul. No. 32).

A common disadvantage of the known mobile coffee shops is their limited use, namely, the prohibition to drive or the inability to drive up by car to certain places of leisure (parks, public gardens, walking areas, beaches and other recreational areas), as well as direct contact of the coffee server with products during cooking beverages that is of particular importance for epidemiological measures.

The task of the invention is to build a mobile self-contained coffee shop, the design of which allows cooking beverages regardless of the presence of an electric grid in places of leisure, particularly, in parks, public gardens, walking areas, on beaches and in places of public events where a mobile coffee shop designed on the basis of a car cannot drive up, as well as to increase the safety of consumer services, by removing the coffee server (operator) from direct contact with products during cooking coffee and coffee beverages.

The set task is solved by the fact that the mobile self-contained coffee shop containing a coffee machine, a water tank, an independent voltage source, an inverter connected to the coffee machine for transforming current from an independent voltage source, according to the invention has a body with a lid, inside which a coffee machine using coffee capsules or coffee pods is placed, to which the water tank, the independent voltage source, the inverter, a container for milk powder with a dispenser, a container for consumables, a container for used capsules are connected, control buttons for turning on the coffee machine, selecting a drink, choosing a portion of milk powder and a neck for filling the container with water from water tank are mounted on the body, and a hole is made in the body on the side surface, in which the outlet of the coffee machine is located, the outlet of the dispenser and the stand for the container for beverage cooked.

In addition, a rechargeable battery is used as an independent voltage source, and a charger connector is installed on the body.

Sometimes, as an independent voltage source, a replaceable battery is used.

Besides, a replacement disposable bag is used as a container for used capsules.

It is better when the lid is designed as hinged one with fixation in a vertical position that allows placing the prices for coffee and coffee beverages on its inner side.

The use of the body with the lid to accommodate all the necessary equipment for cooking coffee and coffee beverages allows it to be conveniently and safely placed on the luggage rack of a bicycle or handcart, which ensures the mobility and self-containment of the coffee shop. In addition, the placement of equipment and consumables inside the body, particularly, coffee capsules or coffee pods, sugar, disposable containers beverage cooked, etc., protects them from dust, debris and other unfavourable conditions in an open space in places of leisure which allows meeting sanitary standards of public catering.

The use of a coffee machine on coffee capsules or coffee pods and a container for powder milk with a dispenser allows cooking coffee and coffee beverages without direct contact of the coffee server (operator) with the product (coffee and powder milk), which increases the safety of consumer servicing.

Placing the container for consumables inside the body, in which coffee capsules and/or coffee pods, disposable containers, sugar sticks, etc., allows storing all the necessary consumables along with other equipment and organise cooking coffee and coffee beverages as soon as possible, provides mobility and self-containment of the coffee shop.

The presence of a container for used capsules inside the body allows them to accumulate and dispose in specially designated places without leaving litter at the location of a mobile self-contained coffee shop and therefore meeting sanitary standards and improving the quality of consumer service in open space in places of leisure.

The control buttons for turning on the coffee machine, choosing a beverage, and choosing a dose of powder milk resting on the body avoids direct contact of the coffee server (operator) with the products during cooking coffee and coffee beverages, acquires particular importance when carrying out anti-epidemic measures, and, moreover, does not require professional knowledge and special skills for cooking coffee and coffee beverages of the coffee server (operator).

The location of the neck for filling the water container with water on the body eliminates the need for access to the inside of the body to fill the water container with water, which makes it impossible for dust and debris to get inside the body and allows meeting the sanitary standards of public catering, and, in addition, provides the convenience of using a mobile self-contained coffee shop.

The location of the stand for a container for cooked beverage, and this can be a plastic or paper cup, or something from which one can drink, the outlet of the dispenser and the outlet of the coffee machine inside the body with free access through the hole made on the side surface of the body allows conveniently placing the mobile self-contained coffee shop on the luggage rack of a bicycle or handcart and safely transport it, since all equipment is located inside the body closed with a lid (during transportation) and does not have any protruding parts. In addition, this design provides the convenience of using a mobile self-contained coffee shop.

To ensure self-contained operation of the coffee shop, a rechargeable battery is used, for which a charger connector is installed on the body.

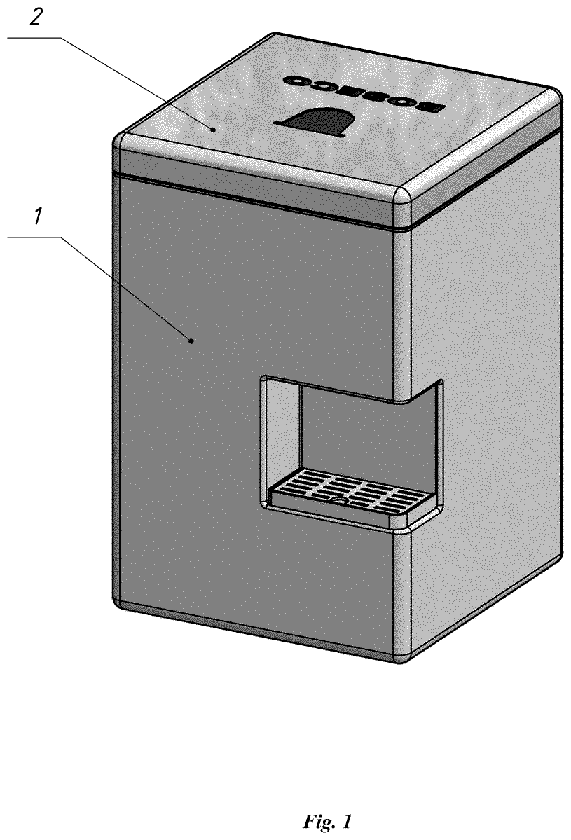

FIG. 1 shows a general view of the mobile self-contained coffee shop.

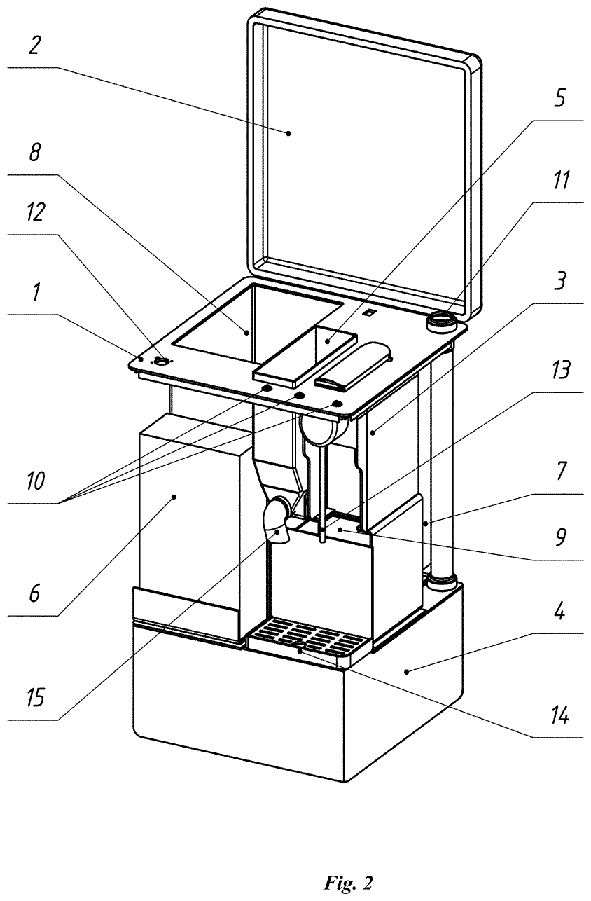

FIG. 2 shows a construction arrangement of the mobile self-contained coffee shop.

The design scheme, as well as the description of implementation and use of a mobile self-contained coffee shop in no way limit the scope of the claims, but only explain the essence of the invention.

A mobile self-contained coffee shop consists of body 1 and lid 2. Inside body 1 there is coffee machine 3, which operates on coffee capsules or coffee pods and is connected to water tank 4, container for powder milk 5 with a dispenser (not indicated in FIG. 2), independent voltage source 6, in particular a battery connected to coffee machine 3 through inverter 7, container for consumables 8, and container for used capsules 9. On body 1 there are control buttons 10 (turning on the coffee machine, selecting coffee, selecting milk), neck 11 for filling water tank 4 and connector 12 of the charger for recharging the battery, which can be used as independent voltage source 6. In the opening of body 1 there is outlet 13 of coffee machine 3, stand for containers intended for cooked beverage 14 and outlet 15 of the dispenser.

The mobile self-contained coffee shop works in the following way.

To start work, water is poured into water tank 4 through neck 11 and the connection of independent voltage source 6 is checked, container for powder milk 5 is filled with powder milk, and coffee capsules or coffee pods, sugar sticks, disposable cups, paper napkins, disposable bags, etc. are loaded into container for consumables 8. After that, on a bicycle or a handcart, the mobile self-contained coffee shop is droved and installed in the places of public amusement, where the mobile coffee shop, built on the basis of a car, cannot drive up.

To cook coffee with milk at the request of the consumer, using control buttons 10, the operator (coffee server) of the mobile self-contained coffee shop feed powder milk from powder milk container 5 through outlet 15 of the dispenser into a paper or plastic cup for beverage cooked pre-installed on container holder 14, etc. Using control buttons 10, the operator (coffee server) of the mobile self-contained coffee shop turns on the coffee machine and adds a portion of hot water from outlet 13 of the coffee machine into a paper or plastic cup, etc. with a portion of powder milk. Then the operator (coffee server) of the mobile self-contained coffee shop places coffee capsules (for coffee machines using coffee capsules) or coffee pods (for coffee machines using coffee pods) containing a certain portion of coffee with certain organoleptic characteristics into coffee machine 3. Employing control buttons 10, the coffee server turns on the coffee machine and selects the type of coffee according to the customer's order. Coffee machine 3, according to the known in the art the principle of operation of a coffee machine using coffee capsules or a coffee machine using coffee pods, depending on the type and technique of beverage cooking, cooks the beverage selected by the consumer. Beverage cooked is added through outlet 13 of the coffee machine to a paper of plastic cup set in advance on a container stand 14, etc. with dissolved milk. Used capsules or pods are collected in container for used capsules 9.

To cook coffee (without milk), the operator (coffee server) of the mobile self-contained coffee shop places a coffee capsule (for coffee machines using coffee capsules) or coffee pod (for coffee machines using coffee pods) containing a certain dose of coffee with certain organoleptic characteristics into coffee machine 3. Employing control buttons 10, the coffee server turns on the coffee machine and selects the type of coffee according to the customer's order. Coffee machine 3, according to the known in the art principle of operation of the coffee machine using coffee capsules or the coffee machine using coffee pods, depending on the type and technique of beverage cooking, cooks the beverage selected by the consumer. The beverage cooked is added through outlet 13 of the coffee machine into a paper or plastic cup set in advance on container stand 14, etc. Used coffee capsules or pods are collected in container 9 for used capsules.

The number of cooked portions of coffee or coffee beverages depends on the volume of the water tank and the characteristics of the independent voltage source, taking into account the overall size and shape of the mobile self-contained coffee shop, which should be such as to conveniently move it using a bicycle or handcart to in the places of public amusement, to which the mobile coffee shop cannot be driven up by car.

The proposed mobile self-contained coffee shop makes it possible to cook and sell high-quality coffee and coffee beverages directly in the places of public amusement, easily changing its location, and thus, reaching a wide range of consumers.

1. The mobile self-contained coffee shop, which contains a coffee machine, a water tank, an independent voltage source, an inverter connected to the coffee machine for transforming current from an independent voltage source, characterized in that it has a body with a lid, inside which a coffee machine using coffee capsules or coffee pods is placed, to which the water tank, the independent voltage source, the inverter, a container for milk powder with a dispenser, a container for consumables, a container for used capsules are connected, control buttons for turning on the coffee machine, selecting a drink, choosing a portion of milk powder and a neck for filling the container with water from water tank are mounted on the body, and a hole is made in the body on the side surface, in which the outlet of the coffee machine is located, the outlet of the dispenser and the stand for the container for beverage cooked.

2. The mobile self-contained coffee shop according to claim 1, characterized in that a rechargeable battery is used as an independent voltage source, and a charger connector is installed on the body.

3. The mobile self-contained coffee shop according to claim 1, characterized in that a replaceable battery is used as an independent voltage source.

4. The mobile self-contained coffee shop according to claim 1, characterized in that a replacement disposable bag is used as a container for used capsules.

5. The mobile self-contained coffee shop according to claim 1, characterized in that a lid is designed as hinged one with fixation in a vertical position that allows placing the prices for coffee and coffee beverages on its inner side.
